(19) United States
(12) Patent Application Publication
(10) Pub. No.: US 2006/0101267 A1
(43) Pub. Date: May 11, 2006

(54) Key management system

(76) Inventors: Itaru Takamura, Saitama (JP); Kazuyuki Yoshida, Saitama (JP)

Correspondence Address: NIXON & VANDERHYE, PC, 901 NORTH GLEBE ROAD, 11TH FLOOR, ARLINGTON, VA, 22203, US

(21) Appl. No.: 10/527,992

(22) PCT Filed: Sep. 19, 2003
(86) PCT No.: PCT/JP03/12022

§ 371 Date: Mar. 21, 2005

(30) Foreign Application Priority Data
Sep. 20, 2002 (JP) 2002-276306

(51) Int. Cl. H04L 9/00

(52) U.S. Cl. 713/171

(57) ABSTRACT

An information provider encrypts a content by a first encryption key so as to generate an encrypted content and encrypts a first encryption key corresponding to the first encryption key by a second encryption key so as to generated key information. The information provider provides the encrypted content and the encrypted key information in the form of a recording medium or the like to an information receiver. Moreover, the information provider has information for generating a second decryption key corresponding to the second encryption key in advance, uses it to acquire the first decryption key, and furthermore can decrypt and play back the content by using the first decryption key. The first decryption key and the second decryption key are distributed to the information receiver according to a key management method utilizing a tree structure in which an information receiver is allocated to a leaf. Here, the tree structure is divided into a plurality of hierarchies so as to define a plurality of partial trees and key information is allocated on the partial tree basis, thereby reducing the information amount of the key information to be held by the information receiver.

### TECHNICAL FIELD

The present invention relates to a key management system using a tree structure and having a function of revoking a specific receiver.

### BACKGROUND TECHNIQUE

In order to protect copyright of contents being literary works such as a movie and music, it is broadly carried out that contents are provided after being encrypted by using information.

As an example of such a system, plural device keys are given to a playback apparatus, and the encrypted contents and such key generation information that only a playback apparatus permitted to play back the contents can generate a decryption key of the contents are recorded on a recording medium. The playback apparatus permitted to play back the contents generates the decryption key of the contents from the key generation information, and decrypts the contents by using the decryption key to play back them. On the contrary, since a playback apparatus which is not permitted to play back the contents (revoked) cannot generate the decryption key of the contents, it cannot play back the encrypted contents.

In such a system, there is proposed a key management system using a tree structure as a technique of managing key information. As examples thereof, there are known “The Complete Subtree Method”, “The Subset Difference Method” and the like (see Dalit Naor, Noni Naor and Heff Lotspiech, “Revocation and Tracing Schemes for Stateless Receivers”, Lecture Notes in Computer Science, Vol. 2139, pp. 41-62, 2001, for example). In these systems, when the key generation information for generating the decryption key of the contents is illegally disclosed or leaked, a process of revoking he key generation information is possible.

In addition, there is also proposed a method of protecting digital contents based on the above-mentioned system (see Toshihisa NAKANO with 3 other people, “Key Management System for Digital Contents Protection—Tree Pattern Division Method”, Proceedings of the 2002 Symposium on Cryptography and Information Security, on Feb. 1, 2002).

In the above-mentioned “The Subset Difference Method”, since a receiver must have keys assigned to all differential subsets to which the receiver belongs, the receiver must have large storage capacity. Though the information amount can be reduced by using a pseudo random number generator, information storage capacity of 10 times larger or more is necessary in comparison with “The Complete Subtree Method”. On the contrary, according to “The Complete Subtree Method”, information amount to be stored by the receiver is small, but the key information amount transmitted to the receiver (recorded on a recording medium, when the recording medium is used for transmitting the information) becomes too large.

### DISCLOSURE OF INVENTION

The present invention has been achieved in order to solve the above problems.

According to one aspect of the present invention, there is provided a key management system including: a unit which defines a tree structure assigning plural information receivers to leaves; a unit which divides the tree structure into predetermined layers and defines plural sub-trees; and a unit which assigns key information to each of the plural sub-trees.

### BRIEF DESCRIPTION OF THE DRAWINGS

FIGS. 1A and 1B are diagrams showing models of a key management system using a tree structure;

FIG. 2 is a diagram showing an example of the tree structure used by the key management system;

FIGS. 3A and 3B are diagrams showing examples of the tree structure used by the key management system;

FIG. 4 is a diagram showing an example of the tree structure of the key management system with layer division;

FIG. 5 is a diagram showing another example of the tree structure of the key management system with the layer division;

FIG. 6 is a diagram showing still another example of the tree structure of the key management system with the layer division;

FIG. 7 is a diagram showing still another example of the tree structure of the key management system with the layer division;

FIG. 8 is a graph for comparing key information sizes on sides of a recording medium and a receiver in plural key management systems;

FIG. 9 is a block diagram showing a configuration of a contents recording system according to an embodiment of the present invention;

FIGS. 10A to 10E show signal contents of each unit in the contents recording system shown in FIG. 9;

FIGS. 11A and 11B show the signal contents of each unit in the contents recording system shown in FIG. 9;

FIG. 12 is a block diagram showing a configuration of a contents playback system according to an embodiment of the present invention;

FIGS. 13A and 13B show signal contents of each unit in the contents playback system shown in FIG. 12;

FIGS. 14A to 14D show the signal contents of each unit in the contents playback system shown in FIG. 12;

FIG. 15 is a flow chart of a contents recording process;

FIG. 16 is a flow chart of a choosing process of a decryption key in the contents recording process;

FIG. 17 is a flow chart of a contents playback process; and

FIG. 18 is a flow chart of a process of assigning keys to subsets by the key management system of the present invention.

### BEST EMBODIMENT FOR EXERCISING THE INVENTION

The preferred embodiments of the present invention will now be described below with reference to the attached drawings. First, the key management system will basically be explained, and then a system of the present invention will be explained.

(1.1) Key Management System with Receiver Revocation Function

In a system in which a sender transmits identical data to a large number of receivers, there is a method in which a reliable key management organization distributes confidential information to decrypt the transmitted information to all the receivers in advance, and the sender encrypts and transmits the information to the receivers so that the receivers who does not have the confidential information cannot decrypt the transmitted information. In this case, there is such a problem that, if all the receivers have the identical confidential information, once a malicious receiver publishes its confidential information, it becomes possible for any person to decrypt the information transmitted thereafter.

As a countermeasure to this problem, there is a method, i.e., a key management system having receiver revoking function, which disables the decryption of the transmitted information by using the leaked confidential information when the key management organization distributes different confidential information to the receivers and the confidential information of a certain receiver is leaked out. This invention deals with such a key management system.

Here, it is assumed such an application that the information is transmitted only by the one-way transmission from a certain sender to plural receivers, and that the confidential information stored by the receivers can never be altered except for the initial assignment of the confidential information (decryption key, etc.) to the receivers.

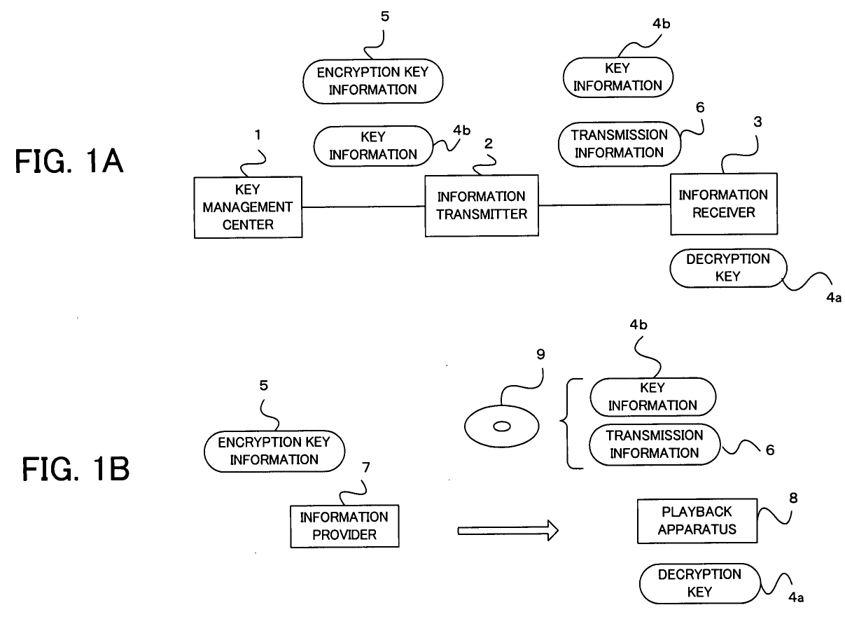

A model of an information providing system, to which the key management system having the receiver revoking function is applied, is shown in FIG. 1A. As shown, the information providing system is constituted by three constitutive elements, i.e., a key management center 1, an information transmitter 2 and an information receiver 3. Each constitutive element will be described below.

Key Management Center

The key management center 1 assigns the receivers confidential information (decryption key 4a of cipher text, etc.) used to decrypt the transmission information (cipher text) 6 transmitted by the information transmitter 2. Also, the key management center 1 generates, from the set of the receivers to be disabled for the decryption of the transmission information 6, the key information 4b by which the receivers other than the receivers belonging to the above set can decrypt the transmission information, and distributes the key information 4b to the information transmitter 2 together with the key (encryption key information 5) used to encrypt the transmission information 6.

It is assumed that the generation, storage and distribution of the confidential information (decryption key 4a, etc.) as well as the key (the encryption key information 5) used to the encryption of the transmission information 6 are carried out safely.

Information Transmitter

The information transmitter 2 encrypts the transmission information 6 by using the encryption key information 5 for encryption of the transmission information distributed by the key management center 1, and transmits the transmission information (the cipher text) to the receivers together with the key information 4b which can be decrypted by the non-revoked receivers.

Information Receiver

When receiving the transmission information 6 (the cipher text), the non-revoked receiver decrypts the key information 4b by using the confidential information (the decryption key 4a of cipher text , etc.) that the receiver stores, and decrypts the transmission information 6 from the cipher text by using the key thus decrypted. On the contrary, the revoked receiver cannot obtain any information relevant to the transmission information even if the plural revoked receivers conspire with each other. Here, presence of a large number of receivers is assumed.

Next, the above-mentioned constitutive elements will be described in detail.

It is assumed that N is a set of all receivers, and the number of its elements is |N|=N. It is also assumed that a subset R of N is a set of the receivers to be revoked, and the number of its elements is |R|=r. The goal of the key management system having the receiver revoking function is that the receivers permitted by the key management system (or the information transmitter), i.e., all the receivers uεN\R who are not included in R can decrypt the transmitted information, and all the receivers included in R who are not permitted can obtain no transmitted information even if they conspire with each other. (a) Key Management Center

(i) Initial Setting

First, subsets S₁, S₂, . . . , S_{w} (^{∀}j, Sⱼ⊂N) of the set N of all the receiver are defined. Each subset Sj is assigned encryption (decryption) key Lⱼ. It is desired that each Lⱼ is uniformly distributed and assigned a value independent of each other. To each of the receivers (the receiving apparatuses) u, the confidential information Iᵤ is assigned. It is necessary that the confidential information Iᵤ is assigned such that all the receivers uεSj included in Sⱼ can obtain the decryption key Lⱼ assigned to the subset Sⱼ to which it belongs, from the confidential information Iᵤ assigned to itself. In addition, the confidential information Iᵤ must be assigned such that all the receivers uεN\Sⱼ who are not included in Sⱼ cannot obtain the decryption key Lⱼeven if they conspire with each other.

(ii) Generating Key Information

(1) The key K (session key) used to encrypt and decrypt transmission information M is selected.

(2) The receivers uεN\R belonging to the complementary set N\R of the set R of the receivers to be revoked are divided into some subsets Sᵢ₁, Sᵢ₂ . . . Sᵢₘ.

$$\underline{N} \backslash \underline{R} = {⋃}_{j = 1}^{m} {S}_{{i}_{j}} \qquad ( 1 \text{-} 1 )$$

It is assumed that the encryption keys assigned to the above subsets by the initial setting are Lᵢ₁, Lᵢ₂, . . . Lᵢₘ.

(3) The Session Key K is Encrypted m Times by Using the Encryption keys Lᵢ₁, Lᵢ₂, . . . Lᵢₘ to generate the following:
<i₁, i₂, . . . , iₘ, E_{enc}(K, Lᵢ_{₁}), E_{enc}(K, Lᵢ_{₂}), . . . , E_{enc}(K, Lᵢ_{ₘ})> (1-2)
and it is distributed to the information transmitter together with the session key K.

We assume that the distribution of the session key K to the information transmitters is securely carried out. Note that E_{enc} indicates the encryption algorithm. There are following two encryption, decryption algorithms used in this system (note that the completely same algorithm maybe used as those two algorithms).

Encryption Algorithm F_{enc} and Decryption Algorithm F_{dec} of the Transmission Information M

Cipher text C_{K}=F_{enc}(M,K) is generated by using the session key K. Processing speed is required.

Encryption Algorithm E_{enc} and Decryption Algorithm E_{dec} of the Session Key K

They are used for the distribution of the session key. The encryption algorithm having higher security than F_{enc} is required.

(b) Information Transmitter

The information transmitter receives the session key K and the key information which can be decrypted by certain receivers from the key management center, encrypts the transmission information M using the encryption algorithm F_{enc} with the session key K, and transmits the cipher text
<[i₁, i₂, iₘ, E_{enc}(K, Lᵢ_{₁}), E_{enc}(K, Lᵢ_{₂}), . . . , E_{enc}(K, Lᵢ_{ₘ})], F_{enc}(M, K)> (1-3)
The portion in square brackets [ ] in the above equation (1-3) is called “header” of F_{enc}(M,K)
(c) Information Receiver

The receiver u receives the following cipher text encrypted by the information transmitter.
<[i₁, i₂, . . . , iₘ, C₁, C₂, . . . , Cₘ], C_{K}> (1-4)
Then, the receiver operates as follows:

(1) Find iⱼ which satisfies uεSᵢⱼ (in case uεR the result is null).

(2) Obtain Lᵢᵢ from the confidential information lᵤ that the receiver has.

(3) Obtain K=E_{dec}(Cⱼ, Lᵢⱼ)

(4) Obtain M=F_{dec}(C_{K}, K).

There are following algorithms which can implement the above key management system:
The Logical Key Hierarchy Method
CPRM Common Cryptographic Key Management
The Complete Subtree Method
The Subset Difference Method
Tree Pattern Division Method

The above methods are different in (1) the definition of the subsets S₁, . . . , S_{w}, of the receivers, (2) the method of assigning keys to the subsets, (3) the method of dividing the set N\R of the receivers for which the reception is permitted (not revoked), (4) the method that each receiver u searches for the subset Sⱼ to which it belongs, and the method of obtaining key Lₛⱼ from Iᵤ.

Those algorithms are evaluated based on following three aspects.

Amount of Transmission Information

The amount of header attached to F_{enc}(M, K), which is generally proportional to m, wherein m is the number of subsets obtained by dividing N\R.

Amount of Confidential Information that the Receiver Stores.

Namely, how much confidential information such as decryption key and the like does a receiver need to store.

Amount of Arithmetic Operation Necessary for the Receiver to Decrypt the Transmitted Information

(1.2) Basic Method (The Subset Difference Method)

(1.2.1) Definition of Subsets S₁, . . . , S_{w}

First, the subsets S₁, . . . , S_{w} of the set N of the whole receivers is defined. To the subsets, information L₁, . . . , L_{w}, from which the encryption (decryption) key or decryption key can be derived, are assigned. Each receiver is assigned to the leaf of a binary tree having N leaves (N is a power of 2).

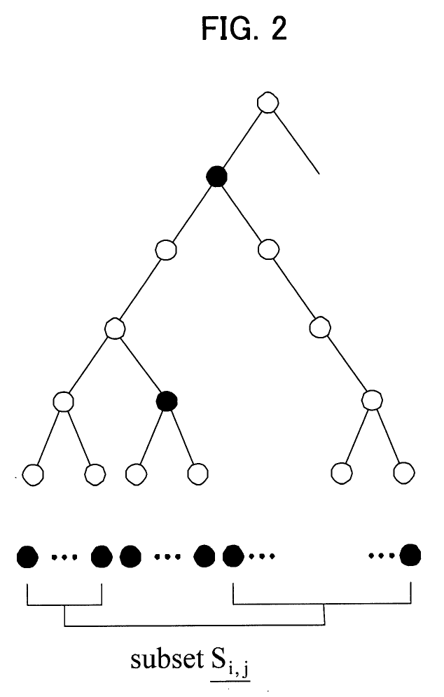

The subsets of the receivers are expressed as follows. The set Sᵢ indicates the set of the receivers assigned to all leaves of the subtree whose root is an arbitrary node vᵢ (root and leaf are included in node) in the binary tree. For the set Sᵢ of the receivers assigned to the leaves below an arbitrary node vᵢ and the set Sⱼ⊂Sᵢ of the receivers assigned to all leaves of the subtree whose root is the node vⱼ (except for the root) in the subtree having the node vᵢ as the root, the differential subset obtained by subtracting the elements of Sᵢ from the elements of Sⱼ is assumed to be S_{i,j}. Namely, out of the receivers included in the set Sᵢ, the set of the receivers which are not included in the set Sⱼ is assumed to be S_{i,j}. FIG. 2 shows S_{i,j}. One key L_{i,j} is assigned to this differential subset.

(1.2.2) Method of Dividing N\R

Next, the description will be given of the method of dividing the set N\R of the receivers permitted the reception (not to be revoked) into the differential subsets S_{i,j} defined above. Consider the subtree ST (R) only consists of the nodes on the shortest path connecting the root of the binary tree and the respective leaves corresponding to the receivers to be revoked. (Such a subtree is uniquely consists of R). For ST (R), the node having no child node is called leaf. The following algorithm is repeated until ST (R) includes only the root node, and the differential subsets consisting N\R are chosen.

(1) Out of the nodes existing on the common portion of the paths from two leaves to the root, the node having the minimum distance to the leaf is called as “minimum common node” of those two leaves. The leaves vᵢ, vⱼ of ST (R) are chosen such that there exists no other leaf below the minimum common node v of them. From two child nodes of v, the child node existing on the path between v and vᵢ is assumed to be vₖ, and the child node existing on the path between v and vⱼ is assumed to be v₁. (When only one leaf exists in ST (R), v may be regarded as the root of ST (R), with assuming that vᵢ=vⱼ, v=vⱼ=vₖ.)

(2) If vₖ≠vᵢ, then add S_{k,i} to the differential subsets consisting N\R. If vₗ≠vⱼ, then add S_{l,j} to the differential subsets constituting N\R.

(3) Remove all the nodes existing below v. Thus, v becomes the leaf.

By using the above algorithm, the set N\R of the receivers is divided into 2r−1 differential subsets at maximum when the number of the receivers to be revoked |R|=r.

(1.2.3) Method of Assigning Keys to Subsets S1, . . . , Sw

Next, the description will be given of the method of assigning the key to each differential subset. We assign keys which are uniformly distributed and independent from each other to the differential subsets.

(1.2.4) Method of Assigning Confidential Information to Receivers

To each receiver, the keys of all the differential subsets to which the receiver belongs must be distributed. This requires remarkably large storage capacity on the receiver side. For each subtree Tₖ to which the receiver belongs, the receiver must store the keys of the number corresponding to the number of all the nodes existing in the subtree Tₖ except for the nodes existing on the path from the root of Tₖ to the receiver u. (Here, the variable k of Tₖ indicates the height of the subtree.) The number of the subtrees to which the receiver belongs is log₂ N, and the height of each subtree is (1≦k≦log₂ N). Hence, the number of the keys that the receiver must store is expressed by the equation (2-1).

$$1 + {\sum }_{k = 1}^{{log}_{2} N} ( {2}^{k + 1} - k - 2 ) \qquad ( 2 \text{-} 1 )$$

(1.2.5) Assignment Method of Keys to Subsets S1, . . . , Sw (Using PRNG)

To reduce the keys which must be stored in the receiver, the keys are not directly assigned to each of the differential subsets S_{i,j}, but one label is assigned to the set Sᵢ, and it is ensured that the key L_{i,j} to be assigned to the differential subset S_{i,j} (^{∀}j, Sⱼ⊂Sᵢ)) can be derived from the label assigned to the subset Sᵢ. In this case, it is required that only the receiver belonging to the differential subset S_{i,j} can derive the key L_{i,j}. The method of realizing the above by using pseudo random number generator will be described below.

Let G:{0,1 }ⁿ→{0,1}³ⁿ be a pseudo random number generator that triples the input, i.e. whose output length is three times the length of the input. Let GL(S) denote the left third of the output of G, GR(S) denote the right third of the output of G and denote GM(S) the middle third of the output of G, when the input to the pseudo random number generator G is S. If the value outputted when the random number is inputted and a truly random string of similar length to the output are given to the attacker having the calculation ability of polynomial-time, the pseudo random number generator must satisfy the characteristic that the attacker cannot distinguish them with significant probability.

Consider now the subtree Tᵢ having the node vᵢ as the root. The LABELᵢ is assigned to the root node vᵢ. (In brief, the assignment of the label to the set of the receivers which are assigned to the leaves of an arbitrary subtree is expressed as assignment of the label to the root node of the subtree. Namely, the above expression is as follows. “The label LABELᵢ is assigned to the set Sᵢ of the receivers which are assigned to the leaves in the subtree Tᵢ”.) It is assumed that LABEL_{i,j} is a label of the node vⱼ in the subtree Tᵢ. (When the label assigned has the parameter of two variables (i and j in this case), it indicates the label assigned to the differential subset. In this case, LABEL_{i,j} is not assigned to the set Sⱼ of the receivers assigned to the leaves of the subtree having vⱼ as the root, but is assigned to the set (differential subset) S_{i,j} of the receivers which are included in Sᵢ and are not included in Sⱼ.) The LABEL_{i,j} is the label assigned to the differential subset S_{i,j}.

By using the pseudo random number generator G, LABEL_{i,j} is derived from the label LABELᵢ assigned to the root vᵢ of the subtree Tᵢ by the following deriving rule. When the label is the input to the pseudo random number generator G, its output is defined as follows. G_{L}—the label of the child node on the left side, G_{R}—the label of the child node on the right side, G_{M}—the encryption (decryption) key assigned to the node to which the input label is assigned. According to this deriving rule, when the label S is assigned to a parent node in the subtree Tᵢ, G_{L}(S) and G_{R}(S) are assigned to its two child nodes, respectively. By deriving the labels to be assigned to the nodes on the path from vᵢ to vⱼ by using G in order, the label LABEL_{i,j} of the node vⱼ in the subtree Tᵢ can be derived from the label LABELᵢ assigned to vᵢ.

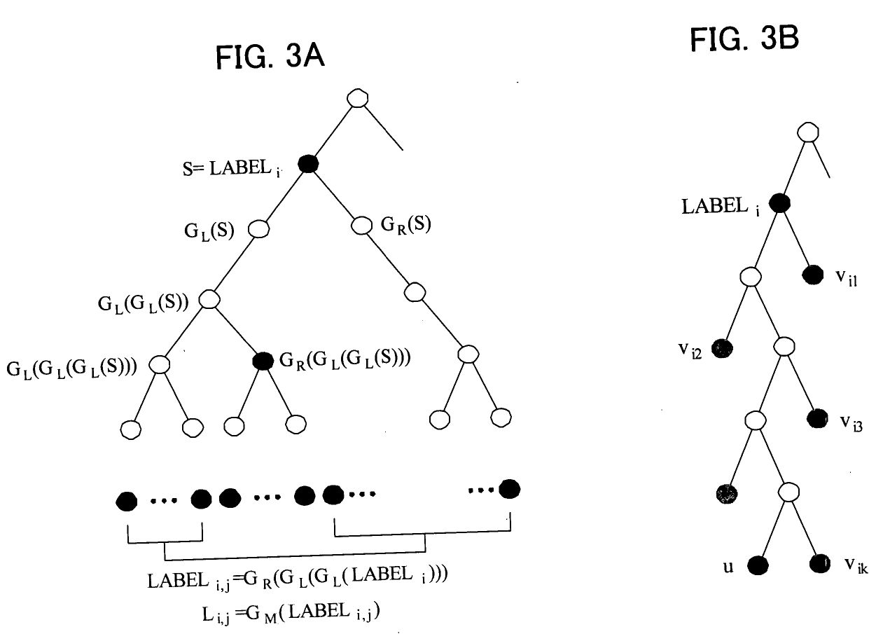

Finally, the center portion Gₘ(LABEL_{i,j}) of the output when the LABEL_{i,j} is inputted to G is used as the encryption (decryption) key L_{i,j} to be assigned to the differential subset S_{i,j}. FIG. 3A shows the method of generating the label and the encryption (decryption) keys assigned to the node vⱼ in the subset Tᵢ.

By using the above method, when a label of a certain node in the subtree is given, all the labels and the encryption (decryption) keys of its child nodes in the subtree can be calculated. Conversely, the label of the ancestor node of a certain node vⱼ cannot be derived from vⱼ. Further, the encryption (decryption) key L_{i,j} cannot be derived from the labels of (not including the label of vⱼ itself) all descendant nodes of the node vⱼ. When the label LABELᵢ of the root of the subtree Tᵢ is given, the pseudo random number generator G is used for (d+1) times at maximum in order to calculate the encryption (decryption) key L_{i,j} assigned to the differential subset S_{i,j}.

(1.2.6) Method of Assigning Confidential Information to Receivers (using PRNG)

The description will be given of the method of assigning the confidential information Iᵤ that each of the receivers stores. For each subtree Tᵢ to which the receiver belongs, the receiver u must be able to calculate the encryption (decryption) key L_{i,j} assigned to the differential subset S_{i,j} determined by the root node vᵢ of Tᵢ and all nodes vᵢ in the subtree Tᵢ which are not the ancestor node of the receiver u. Consider the path from the root node vᵢ of the subtree Tᵢ to the receiver u, and the nodes directly hanging from the path are expressed by vᵢ₁, vᵢ₂, . . . , vᵢₖ (see. FIG. 3B). Namely, they are the nodes which are adjacent to the path and are not the ancestor node of the receiver u. An arbitrary node vⱼ in the subtree Tᵢ which is not the ancestor node of the receiver u is the descendant node of one of the nodes vᵢ₁, vᵢ₂, . . . , vᵢₖ. Therefore, if the receiver u stores the labels assigned to vᵢ₁, vᵢ₂, . . . , vᵢₖ as Iᵤ, the decryption key L_{i,j} assigned to an arbitrary node vⱼ which does not exist on the path in the subtree Tᵢ can be calculated by using the pseudo random number generator for (d+1) times at maximum.

Since there are k labels that the receiver u must store in the subtree Tᵢ of the height k including the receiver u, when considering this for each of the subtree Tᵢ including the receiver u, the number of the decryption keys (labels) that the receiver u must store in advance is expressed by the equation (2-2).

$$1 + {\sum }_{k = 1}^{{log}_{2} N} k = 1 + \frac{( 1 + {log}_{2} N ) {log}_{2} N}{2} = \frac{1}{2} {( {log}_{2} N )}^{2} + \frac{1}{2} {log}_{2} N + 1 \qquad ( 2 \text{-} 2 )$$

In the equation (2-2), “1” is added because the decryption key for the case where there is no receiver to be revoked is necessary.

(1.2.7) Method using Plural Binary Trees

When the confidential information Iᵤ stored by the receiver u is further reduced, it becomes the trade-off with the amount of the transmission information M. As one method, there is a method of using plural binary trees of small height. In the tree structure, each layer at which a node exists is called layer, and they are defined from the layer of the root in order as Layer (0), Layer (1), . . . The binary tree having the leaves to which the receivers are assigned is divided into 2^{b} binary trees having the node existing in the Layer (b) as the root, and the Subset Difference method is applied. In this case, the nodes existing at Layer (0) to Layer(b-1) are not used.

By this, the amount of the information Iᵤ stored by the receiver can be reduced as given by the equations (2-3). However, assuming that the number of the receivers to be revoked is |R|=r, the amount of the transmission information M increases by 2^{b}+2r−1 at the maximum.

$$1 + {\sum }_{k = 1}^{{log}_{2} N - b} k = \frac{1}{2} {( {log}_{2} N - b )}^{2} + \frac{1}{2} ( {log}_{2} N - b ) + 1 \qquad ( 2 \text{-} 3 )$$

(1.3) Method According to the Embodiment (The Layer Division Subset Difference Method)
(1.3.1) Definition of Subsets S₁, . . . , S_{w}

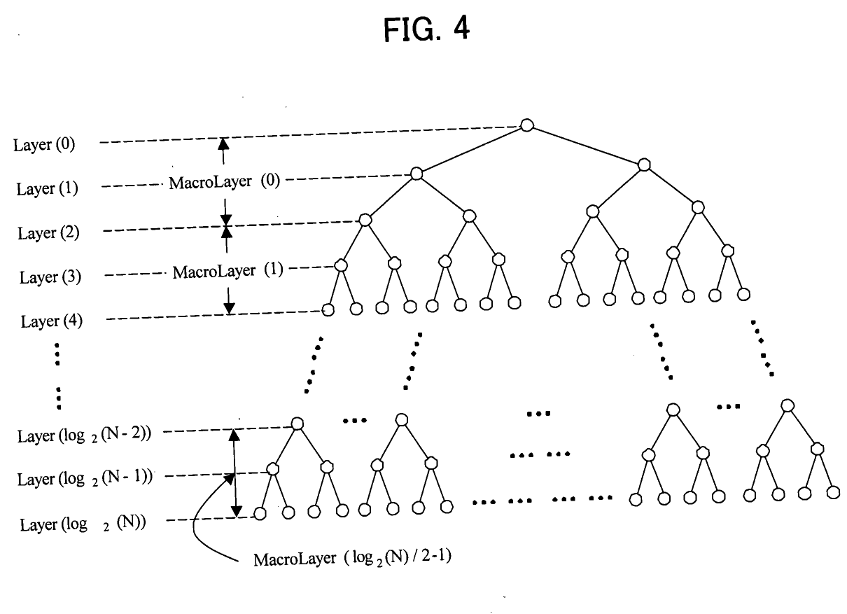

First, the subsets S₁, . . . S_{w} of the set N of the whole receivers is defined. To the subsets, information L₁, . . . , L_{w}, from which the encryption (decryption) key or decryption key can be derived, are assigned. Each receiver is assigned to the leaf of a binary tree having N leaves (N is a power of 2). In the tree structure, each layer having a node is called “layer”, and they are defined as Layer (0), Layer (1), . . . in order from the layer at which root exists. The layer at which the leaf exists is “layer (log₂ N)”. As shown in FIG. 4, the binary tree is divided into the layers of (d+1) levels such that Layer(0)-Layer(d), Layer(d)-Layer(2d), . . . FIG. 4 shows the case of d=2. The layer thus divided is called “macrolayer”, and they are defined from the macrolayer including the root in order as MacroLayer (0), MacroLayer (1), . . . , MacroLayer ( (log₂ N) /d−1) . Each MacroLayer (s) (0≦s≦( (log₂ N)/d−1)) consists of 2^{sd} subtrees Tₕ having the height d dividing the whole binary tree. As a whole, ((1−2^{log2 N})/(1−2^{d})) sub-trees Tₕ exist. Each sub-tree Tₕ (0≦h≦(2^{d}−2^{log 2N})/(1−2^{d})) is considered as a subtree whose leaf the receiver is assigned to. The differential subsets defined in the Subset Difference Method are defined as S₁, . . . , S_{w}, and the encryption (decryption) keys L₁, . . . , L_{w} are assigned. (Actually, the leaf of the subtree Tₕ is merely a node in view of the whole binary tree except for the case that s=(log₂ N)/d−1 (the subtree in the MacroLayer ( (log₂ N)/d−1), and the receiver is not assigned. Therefore, it is regarded that, to the leaf of a certain subtree Tₕ, the set of the receivers assigned to all the leaves existing below the node in the whole subtree corresponding to the leaf.)

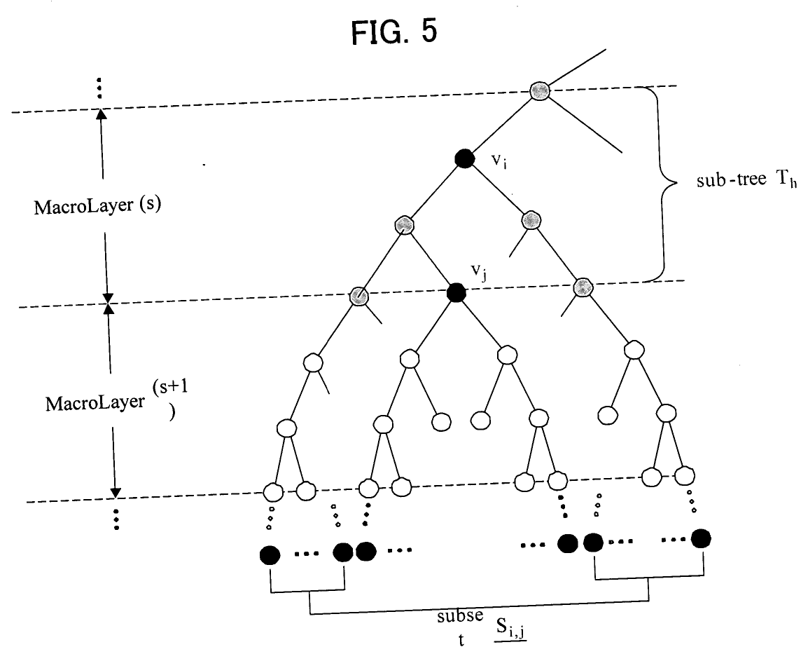

The set Sᵢ indicates the set of the receivers assigned to all leaves of the subtree T_{h,i} whose root is an arbitrary node vᵢ in the subtree Tₕ. For the set Sᵢ of the receivers assigned to the leaves below the node vᵢ and the set Sⱼ⊂Sᵢ of the receivers assigned to the leaves of the subtree T_{h,i} whose root is the node vⱼ (except for the root) in T_{h,i}, the differential subset obtained by subtracting the elements of Sⱼ from the elements of Sᵢ is assumed to be S_{i,j}. FIG. 5 shows S_{i,j}. One encryption (decryption) key L_{i,j} is assigned to this differential subset.

(1.3.2) Method of Dividing N\R

Next, the description will be given of the method of dividing the set N\R of the receivers permitted the reception (not to be revoked) into the differential subsets S_{i,j} defined above. The following process is executed for all the subtrees Tₕ including the leaf to which the receiver to be revoked is assigned or including the leaves to which the set of the receivers including at least one receiver to be revoked.

For the subtree Tₕ including the receiver to be revoked (not permitted), think the subtree STₕ(R) only consists of the nodes on the shortest path connecting the root of the subtree Tₕ and the respective leaves corresponding to the receivers to be revoked (or the set of the receivers to be revoked). (Such a subtree is uniquely consists of R.) For STₕ(R), the node having no child node is called “leaf”. The roots and the leaves used in the following processes (1) to (4) indicate those in the subtree Tₕ.

(1) Out of the nodes existing on the common portion of the paths from two leaves to the root, the node having the minimum distance to the leaf is called “minimum common node” of those two leaves. The leaves vᵢ, vⱼ of STₕ(R) are chosen such that there exists no leaf below the minimum common node of them. From two child nodes of v, the child node existing on the path between v and vᵢ is assumed to be vₖ, and the child node existing on the path between v and vⱼ is assumed to be v₁. (When only one leaf exists in STₕ(R), v may be regarded as the root of STₕ(R), with assuming that vᵢ=vⱼ, v=vⱼ=vₖ.)

(2) If vₖ≠vᵢ, then add S_{k,i} to the differential subsets consisting N\R. If vₗ≠vⱼ, then add S_{1,j} to the differential subsets constituting N\R.

(3) Remove all the nodes of the subtree Tₕ existing below v. Thus, v becomes the leaf.

(4) If there is a node in STₕ(R) other than the root node, the process returns to the process (1). If STₕ(R) includes only the root node, another subtree Tₕ including the receiver to be revoked is chosen, and the process returns to the process (1) to repeat the same process. If STₕ(R) includes only the root node and there is no other subtree Tₕ including the receiver to be revoked, the process ends.

The collection of the differential subsets S_{i,j} obtained by above algorithm is the collection of the differential subsets constituting N\R. The upper limit of the division number (number of the differential subsets constituting N\R) of N\R differs dependently upon the value of d. When d=2 for example (assumed that N is a power of 4), assuming that the number of receivers to be revoked |R|=r, the following equation is obtained.

$$1 + {\sum }_{j = 1}^{r} {f}_{j} \\ {f}_{j} = \{ \begin{matrix}{log}_{4} ( N ) - 1 & ( j = 1 ) \\ {log}_{4} ( N ) & ( j = 2 ) \\ {log}_{4} ( N / {4}^{i} ) & ( 2 \cdot {4}^{i - 1} < j \leq {4}^{i} ) \\ {log}_{4} ( N / {4}^{i} ) - 1 & ( {4}^{i} < j \leq 2 \cdot {4}^{i} and j is odd ) \\ {log}_{4} ( N / {4}^{i} ) & ( {4}^{i} < j \leq 2 \cdot {4}^{i} and j is even ) \\ - 1 & ( 2 \cdot {4}^{{log}_{4} N - 1} < j \leq {4}^{{log}_{4} N} = N )\end{matrix} \qquad ( 3 \text{-} 1 )$$

where “i” is any integer ranged in 0<i<log₄ N.
(1.3.3) Assignment of Key to Subsets S1, . . . , Sw

Next, the description will be given of the method of assigning the key to each differential subset. We assign keys which are uniformly distributed and independent from each other to the differential subsets S_{i,j}. To each of the receivers, all keys assigned to the differential subsets to which the receiver itself belongs are distributed.

(1.3.4) Method of Assigning Confidential Information to Receivers

Consider each of the subtrees Tₕ including the nodes existing on the paths between the leaves to which the receivers u are assigned and the root of the whole binary tree. Such a subtree Tₕ necessarily exists in each MacroLayer. It is assumed that an arbitrary node included in the subtree Tₕ in the nodes on the paths is vᵢ, and that the set of the receivers assigned to the leaves of the subtree T_{h,i} having the root vᵢ is Sᵢ. It is also assumed that the node which is a node of the subtree T_{h,i} and which does not exist on the paths is vⱼ, and that the set of the receivers assigned to the leaves of the subtree T_{h,i} having the root vⱼ is Sⱼ⊂Sᵢ. The set (differential subset) of the receivers which are included in the set Sᵢ and are not included in the set Sⱼ is indicated by S_{i,j}. In this case, the receiver u must have the keys assigned to all the above-mentioned differential subsets S_{i,j}. The number of the subtree Tₕ to which the receiver u belongs is equal to the number of the MacroLayers, and the number is Log₂ N/d. Since the height of the subtree Tₕ is d, there exist d subtrees Tₕ which belong to the subtree Tₕ and have the node vi on the paths as the root. (The case that the node vᵢ corresponds to the leaf of the subtree Tₕ is excluded because it is unnecessary to assign the set of the receivers.) Assuming that the height of the subtree T_{h,i} is k (1≦k≦d), there are {(2^{k+1}−1)−(k+1)} subtrees T_{h,j} which are the nodes in the subtree T_{h,i} and which has the node vⱼ not existing on the paths as the root. Therefore, for the each of the subtrees T_{h,i}, the number of the set Sⱼ is { (2^{k+1}−1)−(k+1)}. Thus, the equation of the differential subset S_{i,j} is expressed as the following equation (3-2). The receiver u must store the keys of the number indicated by the equation (3-2). The reason why “1” is added in the equation (3-2) is that one key is required for the case where there is no receiver to be revoked.

$$1 + \frac{{log}_{2} N}{d} {\sum }_{k = 1}^{d} ( {2}^{k + 1} - k - 2 ) = \frac{4 ( {2}^{d} - 1 ) {log}_{2} N}{d} - \frac{( d + 5 ) {log}_{2} N}{2} + 1 \qquad ( 3 \text{-} 2 )$$

(1.3.5) Assignment Method of Keys to Subsets S1, . . . , Sw (using PRNG)

To reduce the keys which must be stored in the receiver, it is possible to assign the keys to the differential subsets using pseudo random number generator (PRNG) similarly to the Subset Difference Method. Namely, the keys are not directly assigned to the each of the differential subsets S_{i,j}, but one label is assigned to the set Sᵢ of the receivers which are assigned to the leaves of the subtree T_{h,i}. In this case, it is ensured that the key L_{i,j} assigned to the differential subset S_{i,j} (∀j, Sⱼ⊂Sᵢ) can be derived from the label assigned to the subset Sᵢ. In this case, it is required that only the receiver belonging to the differential subset S_{i,j} can derive the key L_{i,j}. The method of realizing the above by using PRNG will be described below.

Let G: {0,1}ⁿ→{0,1}³ⁿ be a pseudo random number generator that triples the input, i.e. whose output length is three times the length of the input. Let G_{L}(S) denote the left third of the output of G on seed S, denote G_{R}(S) the right third of the output of G and denote G_{M}(S) the middle third of the output of G, when the input to the pseudo random number generator G is S. If the value outputted when the random number is inputted and a truly random string of similar length to the output are given to the attacker having the calculation ability of polynomial-time, the pseudo random number generator must satisfy the characteristic that the attacker cannot distinguish them with significant probability.

Consider now the sub-tree T_{h,i} in the MacroLayer(s) having the node vᵢ as the root. The LABELᵢ is assigned to- the root node vᵢ. (In brief, the assignment of the label to the set of the receivers which are assigned to the leaves of an arbitrary subtree is expressed as the assignment of the label to the root node of the subtree. Namely, the above expression is as follows. “The label LABELᵢ is assigned to the set Sᵢ of the receivers which are assigned to the leaves in the subtree T_{h,i}”.) It is assumed that LABELᵢ is a label of the node vⱼ in the subtree T_{h,i}. (When the label assigned has the parameter of two variables, it indicates the label assigned to the differential subset. In this case, LABEL_{i,j} is not assigned to the set Sⱼ of the receivers assigned to the leaves of the subtree having vⱼ as the root, but is assigned to the set (differential subset) S_{i,j} of the receivers which are included in Sᵢ and are not included in Sⱼ.) The LABEL_{i,j} is the label assigned to the differential subset Sᵢⱼ. By using the pseudo random number generator G, LABEL_{i,j} is derived from the label LABELᵢ assigned to the root vᵢ of the subtree T_{h,i} by the following deriving rule.

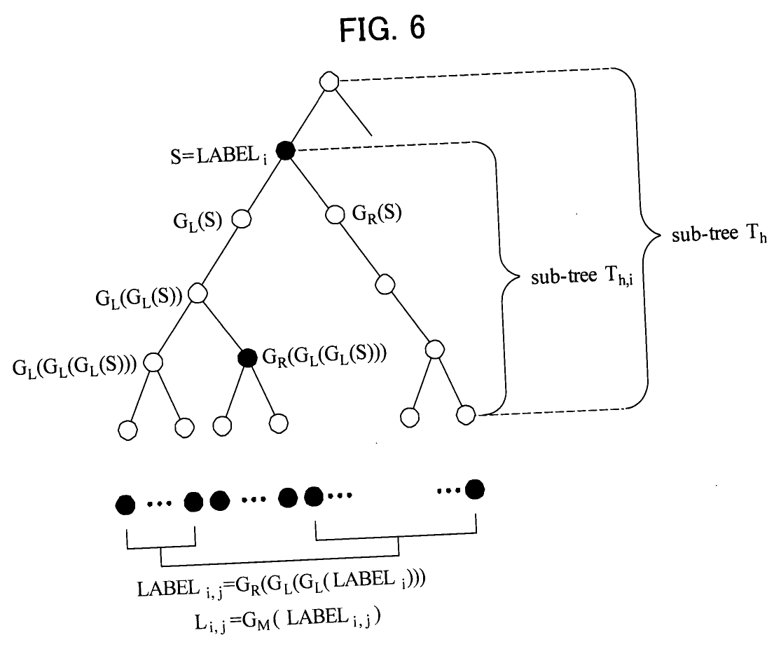

When the label is the input to the pseudo random number generator G, its output is defined as follows. G_{L}—the label of the child node on the left side, G_{R}—the label of the child node on the right side, G_{M}—the encryption (decryption) key assigned to the node to which the input label is assigned. According to this deriving rule, when the label S is assigned to a parent node in the subtree T_{h,i}, G_{L}(S) and G_{R}(S) are assigned to its two child nodes, respectively. By deriving the labels to be assigned to the nodes on the paths from vᵢ to vⱼ by using G in order, the label LABEL_{i,j} of the node vⱼ in the subtree T_{h,i} can be derived from the label LABELᵢ assigned to vᵢ. Finally, the center portion G_{M}(LABEL_{i,j}) of the output when the LABEL_{i,j} is inputted to G is used as the encryption (decryption) key L_{i,j} to be assigned to the differential subset S_{i,j}. FIG. 6 shows an example of assigning key L_{i,j} to the differential subset S_{i,j}.

By using the above method, when a label of a certain node in the subtree is given, all the labels and the encryption (decryption) keys of its child nodes in the subtree can be calculated. Conversely, the label of the ancestor node of a certain node vⱼ cannot be derived from vⱼ. Further, the encryption (decryption) key Lᵢⱼ cannot be derived from the labels of (not including the label of vⱼ itself) all descendant nodes of the node vⱼ. When the label LABELᵢ of the root of the subtree T_{h,i} is given, the pseudo random number generator G is used (d+1) times at maximum in order to calculate the encryption (decryption) key L_{i,j} assigned to the differential subset S_{i,j}.

(1.3.6) Method of Assigning Confidential Information to Receivers (using PRNG)

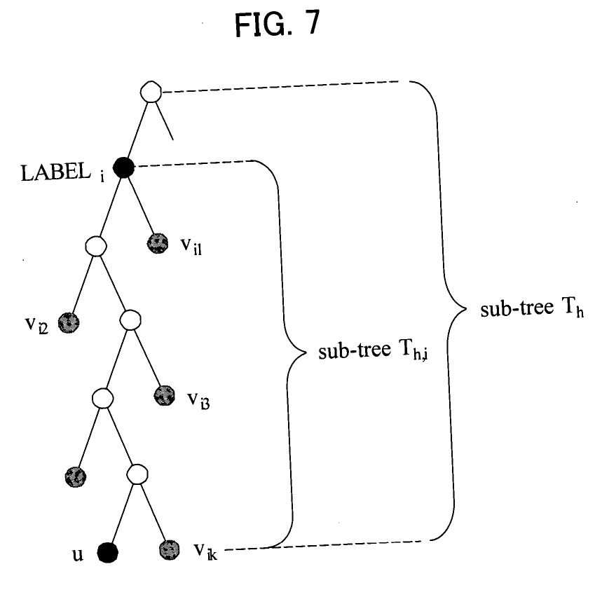

The description will be given of the method of assigning the confidential information Iᵤ that each of the receivers stores. Consider the subtree Tₕ to which every one receiver u existing in each MacroLayer belongs. It is assumed that d nodes on the paths connecting the root of the subtree Tₕ and the leaves to which the receiver u is assigned is vᵢ (nodes of the leaf portion are not counted). The nodes directly hanging from the path, out of the nodes of the subtree T_{h,i} having the root vᵢ and the height k (1≦k≦d) is expressed by vᵢ₁, vᵢ₂, . . . , vᵢₖ (FIG. 7). Namely, they are the nodes among the nodes of the subtree T_{h,i} which are adjacent to the path and which are not the ancestor node of the receiver u. An arbitrary node vⱼ of the subtree T_{h,i} which is not the ancestor node of the receiver u is the descendant node of the nodes vᵢ₁, vᵢ₂, . . . , vᵢₖ. Therefore, if the receiver u stores the labels assigned to vᵢ₁, vᵢ₂, . . . , vᵢₖ as Iᵤ, the decryption key L_{i,j} assigned to an arbitrary node vⱼ which does not exist on the path in the subtree T_{h,i} can be calculated by using the pseudo random number generator (d+1) times at maximum.

The number of the subtrees T_{h,i} including the receivers u is equal to the number of the macrolayer and is log₂ N/d, and d subtrees T_{h,i} in the subtree Tₕ having the node on the path as the root exist. Since there is k labels that the receiver u must store in the subtree Tₕ of the height k, when considering this for each of the subtrees T_{h,i} including the receiver u, the number of the decryption keys (labels) that the receiver u must store is expressed by the equation (3-3).

$$1 + \frac{{log}_{2} N}{d} {\sum }_{k = 1}^{d} k = \frac{( d + 1 ) {log}_{2} N}{2} + 1 \qquad ( 3 \text{-} 3 )$$

In the equation (3-3), “1” is added because the decryption key for the case where there is no receiver to be revoked is necessary, similarly to the equation (3-2). When the keys are assigned to the differential subsets by using the pseudo random number generator, the confidential information stored by the receiver is not the decryption key but the label assigned to each of the subtrees T_{h,i}. However, when no receiver is to be revoked, the key itself is stored as the decryption key.

(1.3.7) Method using Plural Binary Trees

When the confidential information Iᵤ stored by the receiver u is further reduced, it becomes the trade-off with the amount of the transmission information M. As one method, there is a method of using plural binary trees of small height. The binary tree having the leaves to which the receivers are assigned is divided into 2^{b} binary trees having the node existing in the Layer (b) as the root, and the present method is applied to those divided binary trees. In this case, the nodes existing at Layer(0) to Layer (b-1) are not used. By this, the amount of the information Iᵤ stored by the receiver can be reduced as given by the equations (3-4), (3-5). The equation (3-4) shows the number of the decryption keys (labels) to be stored in the case that the pseudo random number generator is not used, and the equation (3-5) shows the number of the decryption keys to be stored in the case that the pseudo random number generator is used. In the equations (3-4) and (3-5), “1” is added because a decryption key is needed for the case where there is no receiver to be revoked in the binary tree having the leaf to which the receiver itself is assigned.

$$\begin{matrix}1 + \frac{{log}_{2} N - b}{d} {\sum }_{k = 1}^{d} ( {2}^{k + 1} - k - 2 ) = \frac{4 ( {2}^{d} - 1 ) ( {log}_{2} N - b )}{d} - \frac{( d + 5 ) ( {log}_{2} N - b )}{2} + 1 & ( 3 \text{-} 4 ) \\ 1 + \frac{{log}_{2} N - b}{d} {\sum }_{k = 1}^{d} k = \frac{( d + 1 ) ( {log}_{2} N - b )}{2} + 1 & ( 3 \text{-} 5 )\end{matrix}$$

For example, when d=2 and the number of the receivers to be revoked |R|=r, the upper limit of the amount of the transmission information M (maximum number of subsets covering the receivers which are not revoked) is given by the equation (3-6).

$${4}^{b} + {\sum }_{j = 1}^{r} {f}_{j} \qquad ( 3 \text{-} 6 )$$

$${f}_{j} = \{ \begin{matrix}{log}_{4} ( N / {4}^{b} ) - 1 & ( 0 < j \leq 2 \cdot {4}^{b} and j is odd ) \\ {log}_{4} ( N / {4}^{b} ) & ( 0 < j \leq 2 \cdot {4}^{b } and j is even ) \\ {log}_{4} ( N / {4}^{b + i} ) & ( 2 \cdot {4}^{b + i - 1} < j \leq {4}^{b + i} ) \\ {log}_{4} ( N / {4}^{b + i} ) - 1 & ( {4}^{b + i} < j \leq 2 \cdot {4}^{b + i} and j is odd ) \\ {log}_{4} ( N / {4}^{b + i} ) & ( {4}^{b + i} < j \leq 2 \cdot {4}^{b + i} and j is even ) \\ - 1 & ( 2 \cdot {4}^{{log}_{4} N - 1} < j \leq {4}^{{log}_{4} N} = N )\end{matrix}$$

Here, “i” is any integer ranged in 0<i<log₄ (N/4^{b})
(1.4) Performance Comparison of those Methods

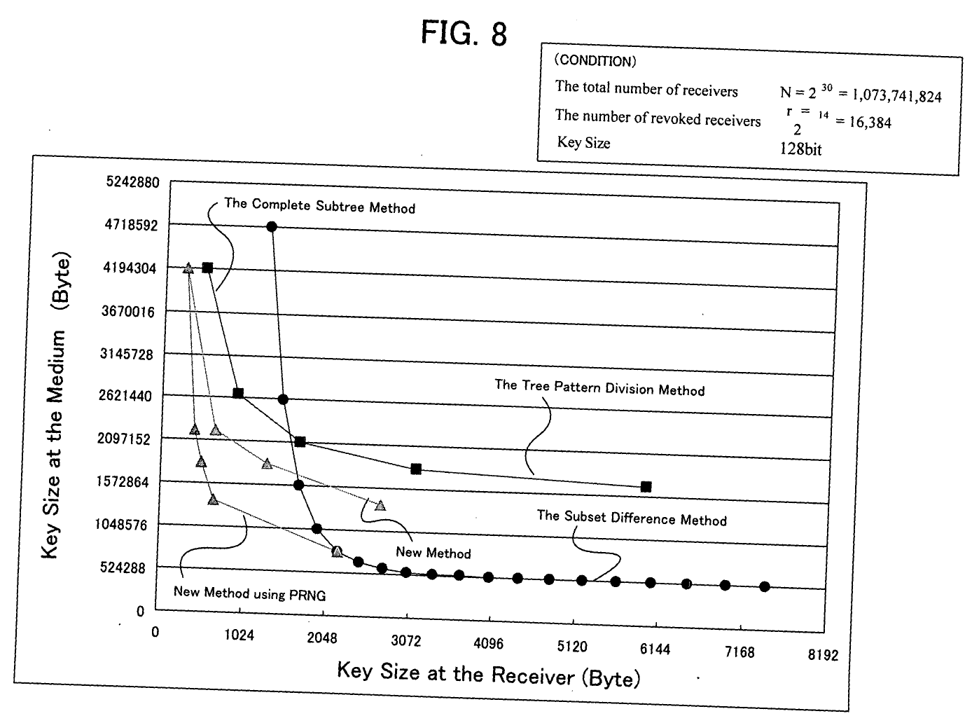

FIG. 8 shows the relations between the amount of the confidential information stored by the receiver and the amount of the header to be transmitted, when the number of all receivers |N|=N and the number of the receivers to be revoked |R|=r are constant. As shown in FIG. 8, it is assumed that N=2³⁰=1,073,741,824, that r=2¹⁴=16384, and that the key length used in each encryption (or decryption) algorithm is 128 bit.

The horizontal axis indicates the amount of the confidential information stored by the receiver, and the vertical axis indicates the upper limit of the amount of the header to be transmitted. The method shown at the lower-left area of the graph needs the information amount to be transmitted or stored is small, and is therefore superior in terms of those two aspects.

In practice of the actual system, the receiver u must determine the decryption key (label information in case that the pseudo random number generator is used in the Subset Difference Method or the Layer Division Subset Difference Method) to be used to decrypt the header information from the confidential information Iᵤ that the receiver itself stores. As the method, there are a method of decrypting all header information by all decryption keys, or a method of adding the information of the decryption key to be used for the decryption (index information of the encryption key used to encrypt the header). In the latter case, the transmission information further increases by the amount of the index information, but this is not considered in FIG. 8.

The reason why there are 19 points (shown by dots) in the Subset Difference Method is that the variable “b” is used as the parameter. From the leftmost point, h=18, 17, . . . , 1, 0 and the rightmost point is corresponding to the method using only one binary tree. As to the assignment of the labels to the differential subsets, only the method using the pseudo random number generator is shown.

The method indicated as “New Method” is the method according to the embodiment of the present invention (The Layer Division Subset Difference Method), which does not use the pseudo random number generator for the assignment of the labels to the differential subsets. The method indicated as “New Method using PRNG” is the method according to the embodiment of the present invention in which the pseudo random number generator is used.

The reason why many points were plotted in the respective methods is that the variable “d” is used as the parameter, and the cases that d=1, 2, . . . are shown from the leftmost one in the right direction. When d=1, the performance (in terms of reducing the amount of the confidential information stored in the receiver) is not improved even if the labels are assigned by using the pseudo random number generator. Although the variable b may be used like the Subset Difference Method, here the parameter b for which the amount of the confidential information stored by the receiver becomes minimum is selected from the parameters for which the transmitted header amount becomes minimum, and only that case is shown. Although FIG. 8 does not show, when d=1, b=0, the algorithm becomes completely equivalent to the Complete Subtree method. When d=16, b=14, the algorithm becomes equivalent to the Subtree Difference Method in which b=14 (the point at which the results of those two method are overlapped). For the Tree Pattern Division Method, not only binary trees but arbitrary n-divided trees are used for the algorithm. Therefore, FIG. 8 shows the results of the cases in which the tree used is the binary tree, 3-divided tree, 4-divided tree, 5-divided tree from the left side. Since the receivers are assigned to the leaves of n-divided trees, the total number of the receivers does not become 2³⁰=4¹⁵=1,073,741,824. Therefore, the following values are used for the 3-divided tree and the 4-divided tree.
3-divided tree: N=3¹⁹=1,162,261,467÷one billion
5-divided tree: N=5¹³=1,220,703,125÷one billion
   In addition, in the case of the binary tree, the algorithm becomes completely equivalent to the Complete Subtree Method.
   (1.5) Contents Delivering System of Embodiment

FIG. 1B schematically shows a configuration of a contents delivering system according to an embodiment of the present invention. In this system, an information provider 7 supplies, to a user, various kinds of recording media 9. In the embodiment, the recording medium 9 may be various kinds of recording media including an optical disc such as a DVD-ROM. The user has a playback apparatus 8, and information is played back from the recording medium 9 by the playback apparatus 8. The playback apparatus 8 has decryption key 4a inside.

The information provider 7 corresponds to the information transmitter in three components of the above-mentioned key management system, and the playback apparatus 8 corresponds to the information receiver. Namely, the information provider 7 encrypts the contents information such as video/sound by using encryption key information 5, and records it on the recording medium 9 as transmission information 6. The information provider 7 records, on the recording medium 9, the key information 4b which cannot be decrypted by the playback apparatus 8 subjected to revocation, but can be decrypted by the playback apparatus 8 which is not subjected to revocation. The information provider 7 supplies the recording medium 9 to the user of each playback apparatus 8.

The playback apparatus 8 which is not subjected to revocation decrypts the key information 4b by its decryption key 4a, and obtains the decryption key of the transmission information 6 to decrypt the transmission information 6 by the decryption key. Thereby, the information such as the video/sound can be played back. On the contrary, the playback apparatus 8 subjected to revocation cannot decrypt the key information 4b in the recording medium 9 by its decryption key 4a. Therefore, the playback apparatus 8 subjected to revocation cannot obtain the key for decrypting the transmission information 6, and cannot play back the transmission information 6. Thus, in the present system, the transmission information 6 recorded on the recording medium 9 can be played back only by a specific playback apparatus 8.

In the present invention, according to the above-mentioned “The Layer Division Subset Difference Method”, the decryption key 4a on the side of the playback apparatus 8 and the key information 4b recorded on the recording medium 9 are generated. Concretely, the decryption key (or a label capable of deriving the decryption key) assigned to all the differential subsets including a certain playback apparatus 8 and one decryption key assigned to the root of the binary tree including the leaf to which the playback apparatus 8 is assigned are distributed to the playback apparatus 8 as the decryption key 4a. Thereby, the information amount of the decryption key 4a stored in the playback apparatus 8 can be remarkably reduced with the increase of the information amount of the key information 4b on the recording medium being suppressed.

Next, the description will be given of the contents delivering system according to the embodiment of the present invention. In the contents delivering system, an optical disc such as a DVD is used as the recording medium, and specifically an example of a DVD-ROM will be explained. In the contents delivering system, the information transmitter corresponds to a copyright proprietor of the contents, a factory for manufacturing optical discs and the like. On the contrary, the information receiver is an apparatus (playback apparatus) having a playback function of the contents, and is constructed by hardware or software.

In an explanation of the embodiment below, Encryption[ ] represents the encryption algorithm, and Decryption[ ] represents the decryption algorithm. Encryption [Argument 1, Argument 2] represents a cipher text obtained by encrypting the argument 1 by using the argument 2 as the encryption key, and Decryption [Argument 1, Argument 2] represents data obtained by decrypting the argument 1 by using the argument 2 as the decryption key. In addition, a mark “|” represents a concatenation of two data, and is used like (data A)|(data B).

(2.1) Contents Recording Apparatus

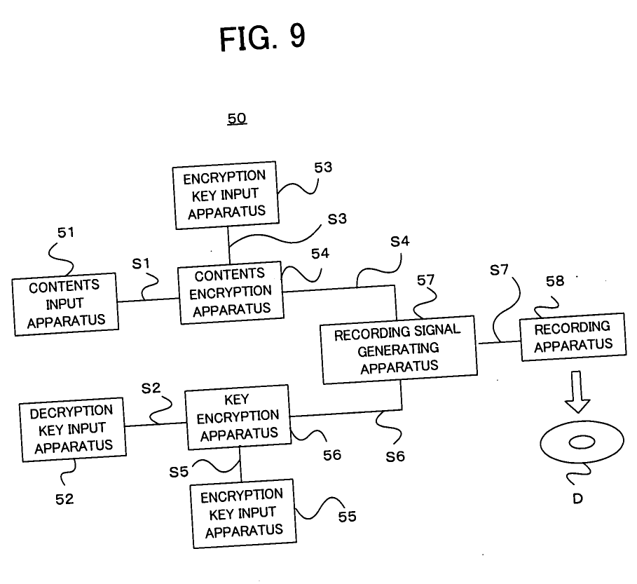

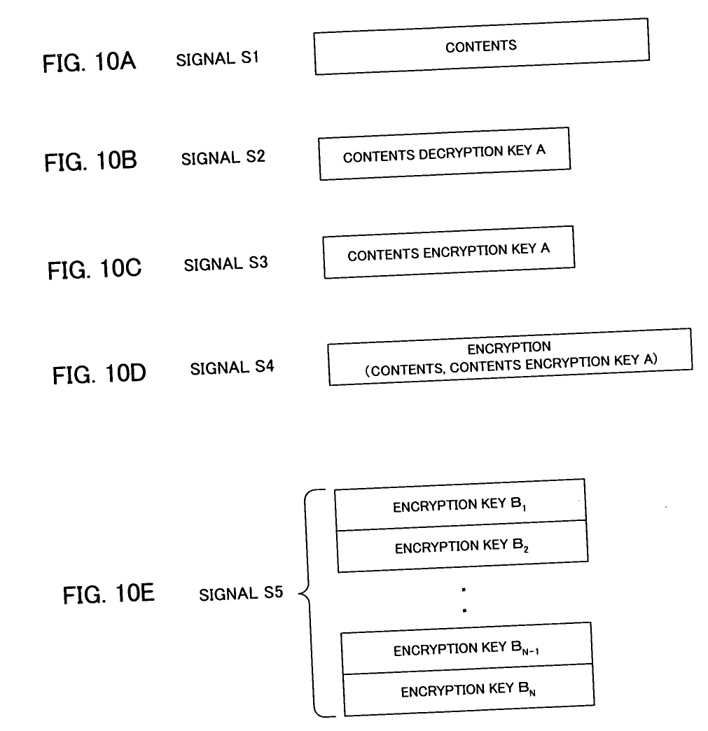

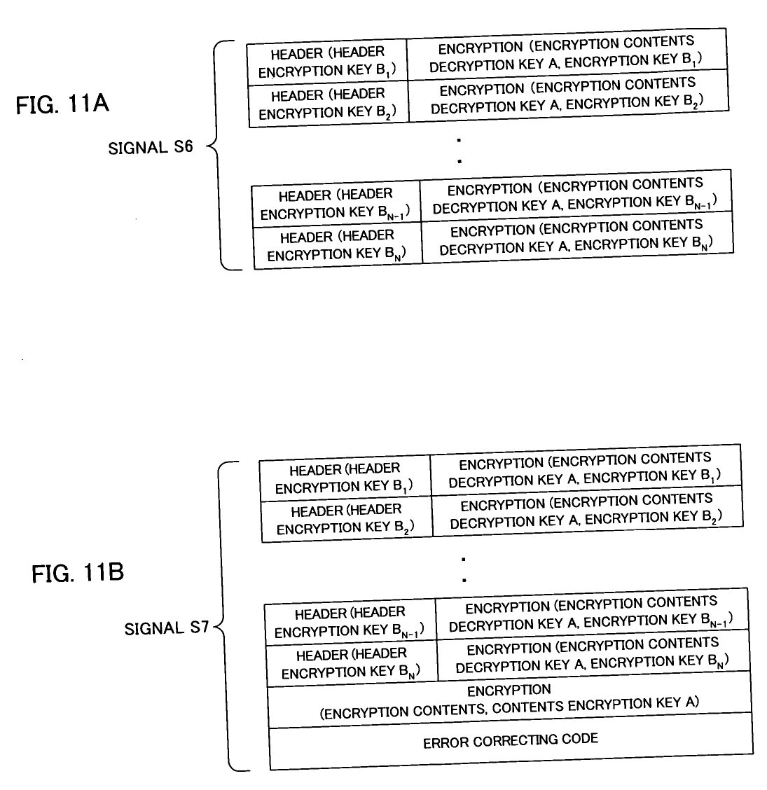

First, the description will be given of a contents recording apparatus. FIG. 9 is a block diagram showing a configuration of a contents recording apparatus 50 which records contents on a disc. The contents recording apparatus 50 is arranged in the above-mentioned disc manufacturing factory as the information transmitter. FIGS. 10A to 10E and FIGS. 11A and 11B show signals S1 to S7 of each portion of the contents recoding apparatus 50. The contents correspond to the above-mentioned transmission information which is transmitted from the information transmitter to the information receiver.

In FIG. 9, a contents input apparatus 51 is used to input the contents, and outputs the signal S1 corresponding to the contents as shown in FIG. 10A. As the contents, multi media data such as sound and video is generally typical. However, the contents of the present invention are not limited to the multi media data, and include data such as a document. The contents input apparatus 51 may be a magnetic tape on which master data of the contents is recorded, a circuit which reads the recording medium such as a DVD-R, a DVD-RW, a DVD-ROM, a DVD-RAM and the like to output the signal S1, a circuit which accesses data via a communication path such as LAN and the Internet and downloads the data to output the signal S1.

The decryption key input apparatus 52 is used to input a key A for decrypting the contents, and outputs the signal S2 being the contents decryption key A as shown in FIG. 10B. The contents decryption key A is determined by the copy right propriet or, the disc manufacturing factory or the key management center, which are the information transmitters.

The encryption key input apparatus 53 is used to input the contents encryption key A, and outputs the signal S3 being the contents encryption key A as shown in FIG. 10C. A relation below is necessary between the contents encryption key A and a contents decryption key A.

P=Decryption [Encryption [Arbitrary data P, Contents encryption key A], Contents decryption key A]

The contents encryption apparatus 54 encrypts the contents (signal S1) by using the contents encryption key A (signal S3), and outputs a signal S4 being the encryption contents. As shown in FIG. 10D, the signal S4=Encryption [Contents, Contents encryption key A].

Though the contents are directly encrypted by using the contents encryption key A in this example, the encryption of the contents is not always necessary. For example, the contents may be decrypted by another encryption key C, and a decryption key C corresponding to the encryption key C may be encrypted by the above-mentioned contents encryption key A to be outputted as the signal S4. Namely, “to encrypt the contents by using the contents encryption key” means that the contents are converted by such a method that the contents decryption key A is at least necessary for decrypting the contents.

The encryption key input apparatus 55 is used to input plural encryption keys Bᵢ for encrypting the contents decryption key A, and chooses N encryption keys B₁, B₂, . . . B_{N-1}, B_{N}, in accordance with the algorithm of the key management system using the above-mentioned Layer Division to output the signal S5. As shown in FIG. 10E, the signal S5=Encryption key B₁|Encryption key B₂| . . . |Encryption key Bᵢ| . . . |Encryption key B_{N-1}|Encryption key B_{N}. By the combination of the plural encryption keys Bᵢ, the playback apparatus (the above-mentioned “receiver which is not subjected to revocation”) capable of playing back the contents is uniquely determined. Therefore, the organization (key management center or information transmitter) having authority for permission of the playback determines the encryption key Bᵢ.

The key encryption apparatus 56 encrypts the contents decryption key A obtained as the signal S2 by using the encryption key Bᵢ obtained as the signal S5, and adds header information Header [Encryption key Bᵢ] to the key to output it as the signal S6. As shown in FIG. 11A, the signal S6=Header [Encryption key B₁] Encryption [Contents decryption key A, Encryption key B₁]|Header [Encryption key B₂]|Encryption [Contents decryption key A, Encryption key B2]| . . . |Header [Encryption key Bᵢ]|Encryption [Contents decryption key A, Encryption key Bᵢ]| . . . |Header [Encryption key B_{N-1}|Encryption [Contents decryption key A, Encryption key B_{N-1}] |Header [Encryption key B_{N}]|Encryption [Contents decryption key A, Encryption key B_{N}].

For convenience of the explanation below, the signal S6=Header [Encryption key B]|Encryption [Contents decryption key A, Encryption key B].

The recording signal generating apparatus 57 synthesizes the encrypted contents and a combination of the contents decryption keys A encrypted by the plural encryption keys Bi, and generates the recording signal. Specifically, the recording signal generating apparatus 57 combines the signal S4=Encryption [Contents, Contents encryption key A] and the signal S6=Header [Encryption key B] | Encryption [Contents decryption key A, Encryption key B], and adds the error correcting signal to them to outputs them as the signal S7. Therefore, as shown in FIG. 11B, the signal S7 is a signal obtained by adding the error correcting code to the contents encrypted by the contents encryption key A, the contents decryption key A encrypted by N encryption keys Bi and the header, and S7=Header [Encryption key B] |Encryption [Contents decryption key A, Encryption key B] |Encryption [Contents, Contents encryption key A] |ECC. It is noted that ECC is the error correcting code.

The recording apparatus 58 records the generated recording signal S7 on an optical disc D (or cuts the recording signal S7 on a master disc for manufacturing the optical disc), and normally includes a laser light source, a laser oscillator and the like.

(2.2) Contents Playback Apparatus

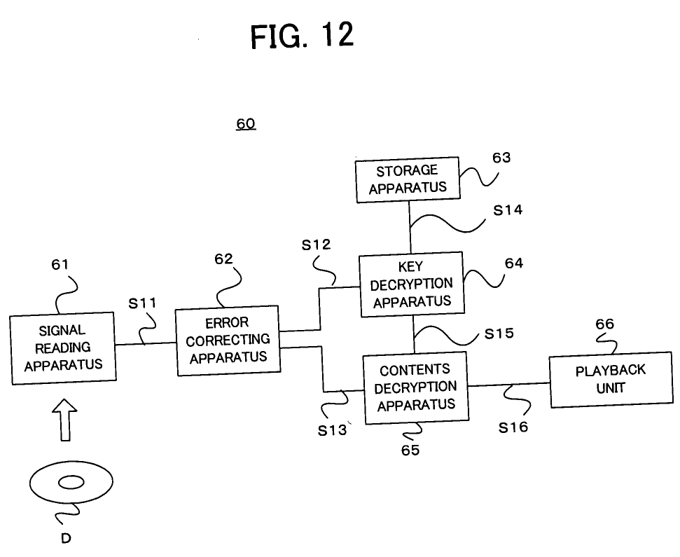

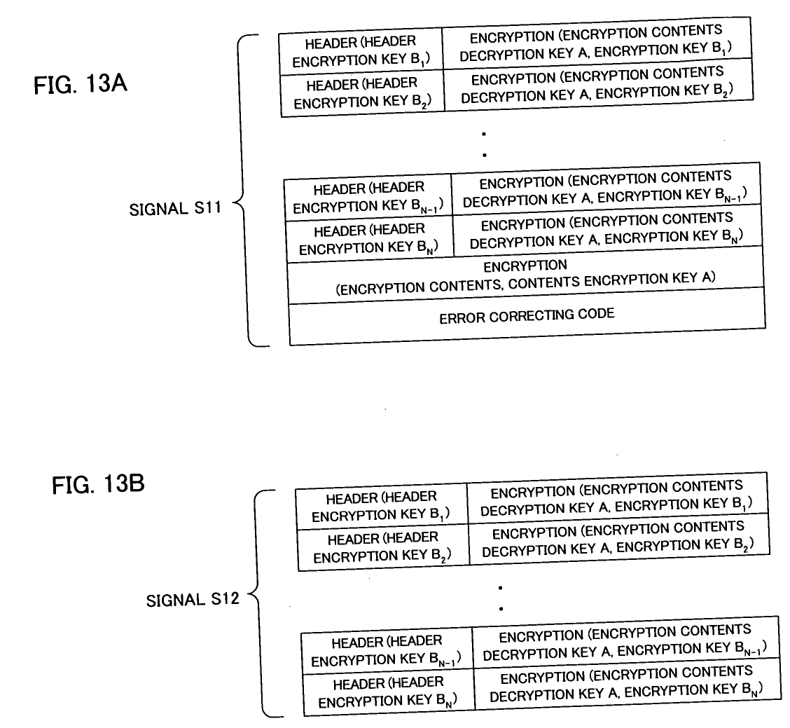

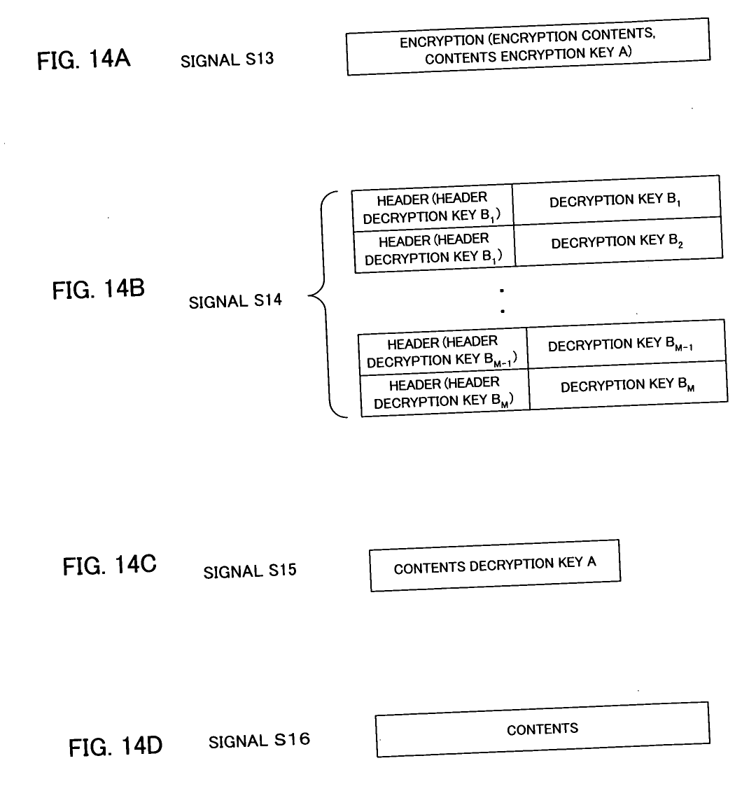

Next, the description will be given of a contents playback apparatus 60 which plays back the contents from the optical disc D on which the contents are recorded by the above-mentioned method. FIG. 12 is a block diagram showing a configuration of the contents playback apparatus 60. In addition, FIGS. 13A and 13B and FIGS. 14A to 14D show signals of each portion of the contents playback apparatus 60.

In FIG. 12, an information reading apparatus 61 is an apparatus such as an optical pickup, and reads the information recorded on the optical disc D to output a signal S11. As shown in FIG. 13A, S11=Header [Encryption key B] |Encryption [Contents decryption key A, Encryption key B] |Encryption [Contents, Contents encryption key A] |ECC.

An error correcting apparatus 62 corrects an error of the inputted signal S11, and executes an error correcting process based on the ECC in the signal S11. Then, the error correcting apparatus 62 divides the signal whose error has been corrected into signals S12 and S13, and supplies them to a key decryption apparatus 64 and a contents decryption apparatus 65, respectively. The signal S12 is data of the contents decryption key A encrypted by the encryption key Bᵢ, and S12=Header [Encryption key B] |Encryption (Contents decryption key A, Encryption key B]. On the contrary, the signal S13 is data of the contents encrypted by the contents encryption key A, and S13=Encryption [Contents, Contents encryption key A].

A storage apparatus 63 stores plural decryption keys B₁, B₂, . . . , Bⱼ, . . . , B_{M-1}, B_{M} stored by the playback apparatus and their headers Header [B₁], Header [B₂], . . . , Header [Bⱼ], . . . , Header [B_{M-1}], Header [B_{M}]. It is assumed that the storage apparatus 63 stores M decryption keys. The key management center distributes the decryption key Bⱼ to the playback apparatus in advance so that at least one of the encryption key Bᵢ for the encryption of the contents decryption key A and the decryption key Bⱼ stored by the playback apparatus permitted to play back the contents have a relation below:

P=Decryption [Encryption [Arbitrary data P, Encryption key Bᵢ], Decryption key Bⱼ].

Further, the value of the header is determined so that a relation below is realized, as for the header added to the encryption key Bᵢ and the decryption key Bⱼ having the above-mentioned relation:

Header [Encryption key Bᵢ]=Header [Encryption key Bⱼ]

The above-mentioned key management center distributes the decryption key Bⱼ and the header thereof to each playback apparatus (at the time of manufacturing the playback apparatus) so that the above-mentioned relation is realized. At that time, which decryption key Bⱼ is distributed to which playback apparatus is determined in accordance with the algorithm of the key management system having the above-mentioned Layer Division. When the pseudo random number generator (PRNG) is used in assigning the key to the differential subset in the above-mentioned algorithm, not the decryption key Bⱼ itself, but the label information necessary for calculating the decryption key is stored in the storage apparatus 63 of the contents playback apparatus 60.

As shown in FIG. 14B, the storage apparatus 63 outputs Decryption key B₁ |Decryption key B₂ | . . . |Decryption key B_{M-1} |Decryption key B_{M} and its header Header [Decryption key B₁] |Header [Decryption key B₂] | . . . |Header [Decryption key B_{M-1} |Header [decryption key B_{M}].

The key decryption apparatus 64 receives the signal S12=Header [Decryption key B] |Encryption [Contents decryption key A, Encryption key B], the signal S14=[Decryption key B₁] |Decryption key B₂ | . . . |Decryption key B_{M-1} |Decryption key B_{M}) and its headers Header [Decryption key B₁] |Header [Decryption key B₂) | . . . | Header [Decryption key Bⱼ] | . . . | Header [Decryption key B_{M-1}] | Header [Decryption key B_{M}]. Then, the key decryption apparatus 64 examines whether or not Header [Encryption key Bᵢ] read from the optical disc D and Header [Decryption key Bⱼ] stored by the playback apparatus coincide with each other. When they coincide, the key decryption apparatus 64 decrypts Encryption [Contents decryption key A, Encryption key Bᵢ] by using the decryption key Bⱼ. Namely, contents decryption key A=Decryption [Encryption [Contents decryption key A, Encryption key Bᵢ], decryption key Bⱼ]. This process is executed with varying the combination of i and j so that the combination of the coincident Headers is found, and a signal S15=contents decryption key A is outputted as shown in FIG. 14C. On the contrary, when the combination of the coincident Headers is not found, it is regarded that the playback is impossible, and the entire process ends.

When, not the decryption key Bⱼ itself, but the label information necessary for calculating the decryption key is stored in the storage apparatus 63 as described above, the similar process may be executed after the key decryption apparatus 64 calculates the decryption key from the label information. Then, the decrypted contents decryption key A is supplied to the contents decryption apparatus 65 as the signal S15.

The contents decryption apparatus 65 receives the signal S13=Encryption [Contents, Contents encryption key A] shown in FIG. 14A and the signal S15=Decryption [Encryption [Contents decryption key A, Encryption key Bᵢ], decryption key Bⱼ]=contents decryption key A shown in FIG. 14C, and decrypts the signal S13 by using the signal S15. As a result, the contents decryption apparatus 65 outputs Decryption [Encryption [Contents, Contents encryption key A], contents decryption key A]=contents as a signal S16. The playback apparatus 66 plays back the contents decrypted by the contents decryption apparatus 65. Then, the contents are played back only by the playback apparatus permitted to play back the contents.

(2.3) Contents Recording Process

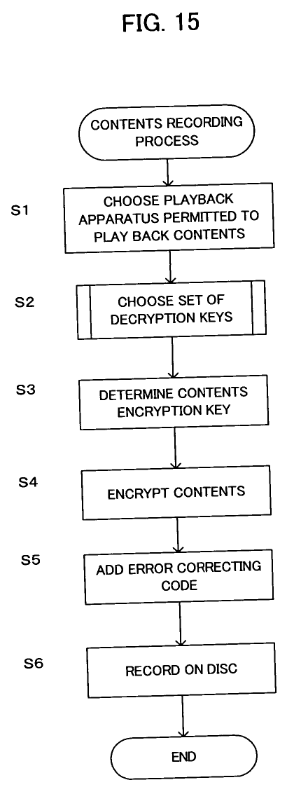

Next, the contents recording process to the optical disc D will be described with reference to FIG. 15. FIG. 15 is a flowchart of the contents recording process. First, from the plural playback apparatuses, one or more playback apparatuses permitted to play back the subject optical disc D are chosen (step S1). This process is generally executed by the key management center, but is sometimes executed by an information transmitter such as a copyright proprietor or a disc manufacturing factory.

Next, a minimum set is chosen from the sets of the decryption keys in which at least one decryption key exist for all the playback apparatuses for which playback is permitted chosen in step S1 and no decryption key exists for the apparatuses for which the playback is not permitted (step S2).

Next, the contents decryption key A is determined, all the decryption keys Bⱼ belonging to the sets of the decryption keys chosen in step S2 are encrypted by using the encryption key Bᵢ satisfying P=Decryption [Encryption [Arbitrary data P, Encryption key Bᵢ], Decryption key Bⱼ] to obtain Encryption [Contents decryption key A, Encryption key Bᵢ] (step S3). Normally, this process is also executed by the key management center, but is sometimes executed by the information transmitter.

Next, the contents is encrypted by using the contents encryption key A chosen in step S3 to obtain Encryption [Contents, Contents encryption key A] (step S4). This process is normally executed by the information transmitter.

Next, an error correction code is added to Encryption [Contents encryption key A, Encryption key Bᵢ] and Encryption [Contents, Contents encryption key A] obtained in steps S3 and S4 (step S5). This process is executed by the information transmitter such as a copyright proprietor or a disc manufacturing factory.

Then, Encryption [Contents decryption key A, Encryption key Bᵢ] and Encryption [Contents, Contents encryption key A] and the error correction code calculated in steps S3, S4 and S5 are recorded on the optical disc D (step S6). This process is executed by the information transmitter such as a disc manufacturing factory. Thus, the encrypted contents and the information of its decryption key are recorded on the optical disc D.

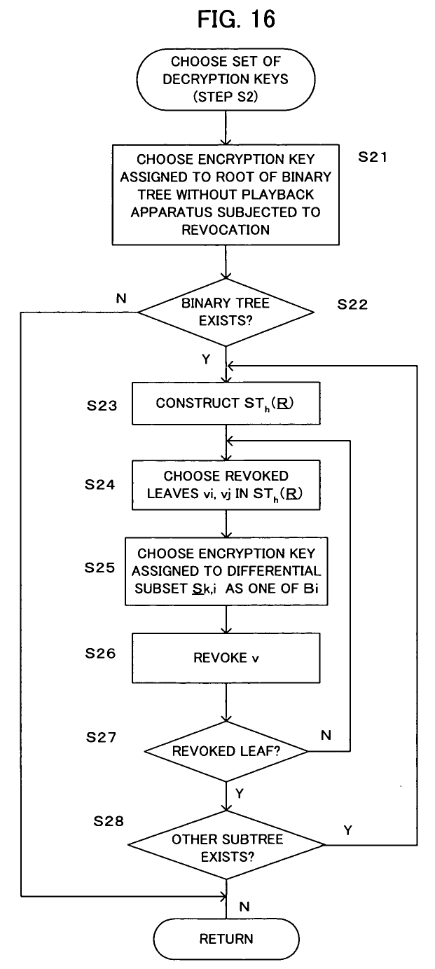

Next, the choosing process of the sets of the decryption keys in the above step S2 will be described with reference to FIG. 16. FIG. 16 is a flowchart specifically showing the process in step S2 of FIG. 15, i.e., the process of choosing a minimum set from the sets of the decryption (encryption) keys in which one decryption (encryption) key exists for all the playback apparatuses for which the playback of the subject disc is permitted and no decryption (encryption) key exists for the apparatuses for which playback is not permitted.

First, from 2^{b} binary trees having leaves to which plural playback apparatuses are assigned, for the binary tree including no playback apparatus to be revoked (playback is not permitted), the decryption key assigned to the root of the binary tree is chosen as the decryption key Bᵢ (step S21). At this time, the binary trees including no playback apparatus to be revoked are eliminated and omitted from the subsequent process.

Next, it is determined whether or not the binary tree exists (step S22). If it exists, an arbitrary subtree Tₕ including the leaf to which the playback apparatus to be revoked or the sets of the playback apparatuses including the playback apparatus to be revoked (these two kinds of leaves are called “revocation leaf”) is chosen to construct STₕ(R) (step S23) . Here, STₕ(R) is a subtree consisting of only the nodes on the shortest path connecting the root of the subtree Tₕ and the revocation leaf. The subtree Tₕ chosen here may be included in any binary tree. Namely, all the binary trees which are not eliminated in step S21 are the subject.

Next, two revocation leaves vᵢ, vⱼ in STₕ(R) are chosen such that no other revocation leaf exists below their common node v (step S24). Here, the common node is a node which exists on the common portion of the paths from the two revocation leaves to the root and whose distance from the revocation leaf is minimum. From two child nodes of v, the child node existing on the path between v and vᵢ assumed to be vₖ, and the child node existing on the path between v and vⱼ is assumed to be v₁. (If only one revocation leaf exists in STₕ(R), vᵢ=vⱼ, v=vₖ=vₗ, and v is the root of STₕ(R).)

Next, if vᵢ≠vₖ, the decryption key assigned to the differential subset S_{k,i} is chosen as one of Bᵢ (step S25) . Similarly, if v₁≠vⱼ, the decryption key assigned to the differential subset S_{l,j} is chosen as one of Bᵢ. When the pseudo random number generator is used for the assignment of the keys to the differential subsets, the encryption keys assigned to the differential subsets S_{k,i}, S_{l,i} by the above process are calculated from the labels assigned to the sets Sₖ, S₁, and the decryption keys are chosen as one of Bᵢ.

Next, all the nodes in the subtree Tₕ located below the node v are eliminated, and v is set to the revocation leaf (step S26). Next, it is determined whether or not the root node in STₕ(R) is there vocation leaf (step S27). If the root node is the revocation leaf, it is determined whether or not other subtree Tₕ including revocation leaf other than the root node exists in all of the binary trees (step S28). If it exists, the process returns to step S23, other subtree Tₕ including revocation leaf other than the root node is chosen, and the same process is repeated.

On the contrary, if it is determined that the root node in STₕ(R) is not the revocation leaf in step S27, the process returns to step S24 to choose other revocation leaf, and the same process is repeated.

In this way, the process ends when other subtree Tₕ including revocation leaf other than the root node does not exist in all of the binary trees (step S28; No). The set of the decryption key Bᵢ used for the encryption of the contents decryption key A is the encryption key chosen in steps S21 and S25 (or calculated from the label).

(2.4) Contents Playback Process

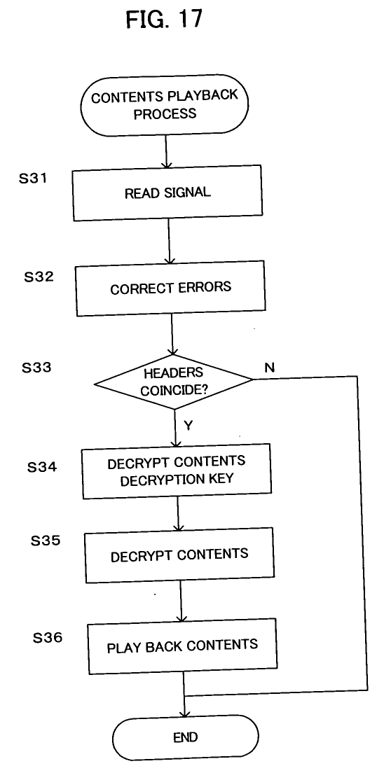

Next, the contents playback process from the optical disc D will be described. FIG. 17 is a flowchart of the contents playback process. First, recorded information is read out from the optical disc D by the reading apparatus 61 such as an optical pickup (step S31). Next, the error correcting apparatus 62 executes the error correction of the signal obtained in step S31 (step S32).

Next, it is determined whether or not N headers Header[Encryption key Bᵢ] recorded on the optical disc D includes the header which is coincident with at least one of M headers Header[Decryption key Bⱼ] of the decryption key Bⱼ stored in the playback apparatus (step S33). If there exists such a header, the playback apparatus is permitted the playback, and Encryption [Contents decryption key A, Encryption key Bᵢ] corresponding to the coincident header Header [Decryption key Bᵢ] on the optical disc D side is decrypted by the decryption key Bⱼ corresponding to the header Header [Decryption Bⱼ] on the playback apparatus side (step S34). Namely, the process: Contents decryption key A=Decryption [Encryption [Contents decryption key A, Encryption key Bᵢ], Decryption key Bⱼ] is executed to obtain the contents decryption key A.

Next, Encryption [Contents, Contents encryption key A] which are the encrypted contents recorded on the optical disc D is decrypted by using the contents decryption key A decrypted in step S34 (step S35). Namely, the process: Contents=Decryption [Encryption [Contents, Contents encryption key A], Contents decryption key A] is executed to decrypt the contents. Then, the contents decrypted are played back (step S36).

It is noted that the coincident header is not found in step S33 (step S33; No), the playback by the playback apparatus is not permitted and the process ends without playing back the contents.

(2.5) In case of using Pseudo Random Number Generator for Assignment of Keys to Differential Subsets

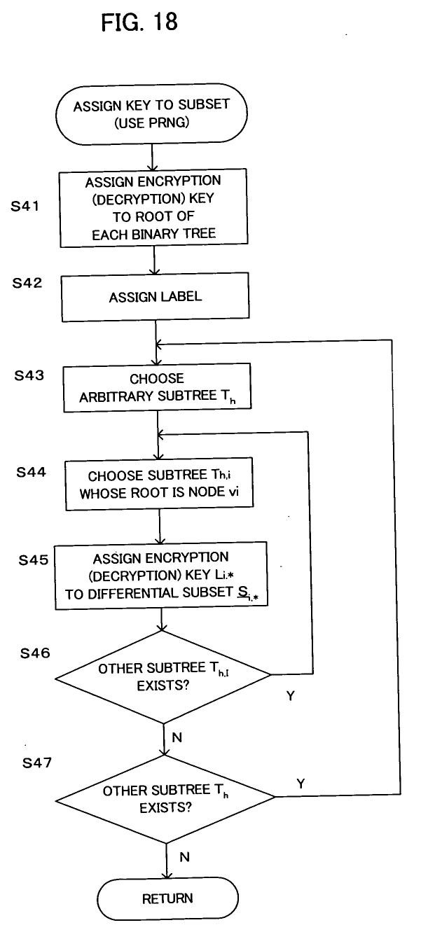

Next, with reference to the flow chart in FIG. 18, the description will be given of the process in which pseudo random number generator is used in assigning the decryption (encryption) keys to the differential subsets according to the key management method having layer division according to the present invention.

First, decryption (encryption) keys having independent values are assigned to the roots of each of 2^{b} binary trees (step S41). Next, labels having independent values are assigned to all the nodes included in the 2^{b} binary trees (step S42). However, the node (leaf) to which only one playback apparatus is assigned is excluded. Then, an arbitrary subtree Tₕ is chosen (step S43), and the subtree T_{h,i} having an arbitrary node vᵢ in the chosen subtree Tₕ as the root is chosen (step S44).

Next, by using the label LABELᵢ assigned to the root node of the subtree T_{h,i} chosen in step S44 (assigned in step S42), the decryption (encryption) key L_{i,*} is assigned to the differential subset S_{i,*} (step S45). Here, “*” indicates an arbitrary node v _{*} of the subtree T_{h,i}. (However, the root node vᵢ of T_{h,i} is excluded.) The assignment of the decryption (encryption) keys to the differential subsets is executed in the following manner.

First, assuming that the input to the pseudo random number generator G is LABEL_{i,*}, the left third of its output is assumed to be G_{L}(LABEL_{i,*}), the center third of its output is assumed to be Gₘ(LABEL_{i,*}), and the right third of the output is assumed to be G_{R}(LABEL_{i,*}). Each of the outputs is defined as follows.

G_{L}(LABEL_{i,*}) Label assigned to the child node on the left of the node to which the input label LABEL_{i,*} is assigned.

G_{M}(LABEL_{i,*}): Decryption key L_{i,*} assigned to the node to which the input label LABEL_{i,*} is assigned. (This becomes the encryption (decryption) key assigned to the differential subset S_{i,*}.) G_{R}(LABEL_{i,*}): Label assigned to the child node on the right of the node to which the input label LABEL_{i,*} is assigned.

By using the pseudo random number generator G, the labels of its two child nodes are assigned from the labels LABELᵢ assigned to the root nodes of the subtree T_{h,i}. This process is executed next with using the labels of the child nodes as the input to obtain the labels of the descendant nodes. In the same manner, the label can be assigned to all nodes in the subtree T_{h,i}.

Finally, L_{i,*}=G_{M}(LABEL_{i,*}) is calculated with using the label LABEL_{i,*}assigned to each node in the subtree T_{h,i} as the input. This value is the encryption (decryption) key assigned to the differential subset S_{i,*}.

Next, it is determined whether or not the subtree which is not chosen in step S44 exists in the subtree T_{h,i} in the subtree Tₕ chosen in step S43 (step S46). If it exists, the process returns to step S44 to choose the subtree T_{h,i} which is not chosen yet, and the same process is executed. If it does not exist, then it is determined whether or not there exists the subtree Tₕ which is not chosen in step S43 in all the subtrees Tₕ existing in 2^{b} binary trees (step S47). If it exists, the process returns to step S43 to choose the subtree Tₕ which is not chosen yet, and the same process is executed. On the contrary, if it does not exist, the process ends.

As described above, in this embodiment, the binary tree is divided into plural layers to apply the Subset Difference Method to each subtree thus divided. Therefore, confidential information such as decryption key stored by a playback apparatus can be largely reduced with suppressing increase of key information amount in a recording medium.

In a case that pseudo random number generator is used to assign decryption (encryption) key to each differential subset by the Subset Difference Method, an arithmetic operation (to derive output of pseudo random number generator) of (log₂ N+1) times is required, at maximum, to obtain decryption keys from labels stored in a playback apparatus. According to this method, the operation of (d+1) times is enough at maximum. It is noted that “d” is the height of the subtree Tₕ. Therefore, the decryption key can be efficiently and rapidly derived from label information.

### INDUSTRIAL APPLICABILITY

This invention can provide a system capable of revoking a specific receiver who executes an illegal process in circumstances in which the contents being literary works such as a movie and music are encrypted and distributed via a network and other information transmission path.

1-2. (canceled)

3. A key management system comprising:
a unit which defines a tree structure assigning plural information receivers to leaves;
a unit which divides the tree structure into macrolayers of a predetermined number to define plural subtrees;
a unit which independently defines differential subsets of the information receivers for each of the subtrees, the subset being defined by an ancestor node and a descendant node existing in the subtree, the information receivers being assigned to the leaves of the subtree which exist at a layer identical to or below the ancestor node and does not exist at a layer identical to or below the descendant node or assigned to the leaves of the tree structure which exist at a layer below the leaves of the subtree;
a unit which assigns one encryption/decryption key to each of the differential subset; and
a unit which assigns, to each of the plural information receivers, the encryption/decryption key assigned to all the differential subsets to which the information receiver belong.

4. The key management system according to claim 1, further comprising a key information generating unit which generates key information decryptable only by specific information receivers in the plural information receivers assigned to the leaves of the tree structure.

5. The key management system according to claim 1, further comprising a unit which assigns, to specific information receivers in the plural information receivers, confidential information which enables to derive the encryption/decryption key assigned to all the differential subsets including the information receivers.

6. The key management system according to claim 1, further comprising:
a key information generating unit which generates key information decryptable only by specific information receivers in the plural information receivers assigned to the leaves of the tree structure;
a unit which assigns, to the specific information receivers, confidential information which enables to derive the encryption/decryption key assigned to all the differential subsets including the information receivers; and
a unit which derives the encryption/decryption key assigned to all the differential subsets including the specific information receivers by using the key information and the confidential information.

7. A key management method comprising:
a process which defines a tree structure assigning plural information receivers to leaves;
a process which divides the tree structure into macrolayers of a predetermined number to define plural subtrees;
a process which independently defines differential subsets of the information receivers for each of the subtrees, the subset being defined by an ancestor node and a descendant node existing in the subtree, the information receivers being assigned to the leaves of the subtree which exist at a layer identical to or below the ancestor node and does not exist at a layer identical to or below the descendant node or assigned to the leaves of the tree structure which exist at a layer below the leaves of the subtree;
a process which assigns one encryption/decryption key to each of the differential subset; and
a process which assigns, to each of the plural information receivers, the encryption/decryption key assigned to all the differential subsets to which the information receiver belong.

8. A computer product program in a computer-readable medium executed by a key management system comprising a computer, the computer product program making the computer function as:
a unit which divides the tree structure into macrolayers of a predetermined number to define plural subtrees;
a unit which independently defines differential subsets of the information receivers for each of the subtrees, the subset being defined by an ancestor node and a descendant node existing in the subtree, the information receivers being assigned to the leaves of the subtree which exist at a layer identical to or below the ancestor node and does not exist at a layer identical to or below the descendant node or assigned to the leaves of the tree structure which exist at a layer below the leaves of the subtree;
a unit which assigns one encryption/decryption key to each of the differential subset; and
a unit which assigns, to each of the plural information receivers, the encryption/decryption key assigned to all the differential subsets to which the information receiver belong.

9. A recording medium which records the key information generated by the key management system according to claim 2.
